(19) United States
(12) Patent Application Publication
(10) Pub. No.: US 2024/0083756 A1
(43) Pub. Date: Mar. 14, 2024

(54) SILICON-CARBON COMPOSITE MATERIAL, PREPARATION METHOD THEREOF, AND SECONDARY BATTERY

(71) Applicant: Guangdong Kaijin New Energy Technology Co., Ltd., Dongguan (CN)

(72) Inventors: Zhenyu Chen, Dongguan (CN); Anhua Zheng, Dongguan (CN); Dexin Yu, Dongguan (CN); Rusheng Fu, Dongguan (CN); Yunlin Yang, Dongguan (CN)

(21) Appl. No.: 18/507,009

(22) Filed: Nov. 10, 2023

(30) Foreign Application Priority Data
Dec. 14, 2022 (CN) 202211611940.5

(51) Int. Cl. C01B 33/02; C01B 32/05; H01M 10/05

(52) U.S. Cl. CPC C01B 33/02; C01B 32/05; H01M 10/05; C01P 2002/54; C01P 2004/01; C01P 2004/84; C01P 2006/16; C01P 2006/40

(57) ABSTRACT

A silicon-carbon composite material, a preparation method thereof, and a secondary battery are provided. The silicon-carbon composite material includes a silicon-carbon composite core and a carbon coating layer coated on the silicon-carbon composite core, and multiple closed pores are dispersed in the silicon-carbon composite core. The preparation method includes steps of (I) a surface modification treatment of a high-molecular polymer, (II) a preparation of a nano-silicon dispersion, (III) a preparation of a first precursor, (IV) a preparation of a second precursor, and (V) carbon coating. The closed pores in the silicon-carbon composite core can effectively alleviate the significant volume effect of silicon generated during lithium intercalation and deintercalation, and the combination of the silicon-carbon composite core and the carbon coating layer can ensure structural stability and high strength of the material.

### CROSS-REFERENCE TO RELATED APPLICATION

The present application claims priority from Chinese Patent Application No. 202211611940.5 filed on Dec. 14, 2022, the contents of which are incorporated herein by reference in their entirety.

### FIELD OF THE INVENTION

The present invention relates to the field of material preparation technology, in particular to a silicon-carbon composite material, a preparation method thereof, and a secondary battery.

### BACKGROUND OF THE INVENTION

Currently, it is difficult for commercial lithium-ion batteries to meet the requirements of long life battery for new energy vehicles. Therefore, there is an urgent need to develop battery products with higher energy density and longer cycle life. Graphite as a main anode material is used for commercial lithium-ion batteries, but its specific capacity has been close to its theoretical capacity, which severely limits further improvement in the energy of lithium-ion batteries. Silicon-based materials with high theoretical capacity (4200 mAh/g) and suitable discharge platforms have attracted significant attention in the industry. However, silicon also has significant drawbacks. For example, during the lithium intercalation and deintercalation process, silicon may generate significant volume expansion (theoretically up to 300%) and prone to be pulverized, which causes the active materials bonded to the current collector surface to be cracked or even pulverized to lose contact with the electrodes, resulting in complete capacity loss.

Application CN102651476A discloses a method for preparing silicon-carbon composite anode materials for lithium-ion batteries. The silicon-carbon composite anode material has graphite as the core and nano-silicon as the shell, which is obtained by the charge adsorption method of positive and negative ion surfactants in the solution. The composite anode material prepared by this technology has excellent cycle performance. When assembled into a battery with a lithium metal as the counter electrode, the battery including such a silicon-carbon composite anode material exhibits an initial reversible specific capacity of 1100 mAh/g and an initial Coulombic efficiency of 79.8%, the both of which are low, for example, the initial Coulombic efficiency below 80% is still undesirable for the current capacity requirements, thus the practical application of the battery is limited.

Application CN108963208A discloses a method for preparing silicon-carbon anode materials and a lithium-ion battery. The method involves solid-phase mixing and sieving of nano-silicon and graphite, then solid-phase mixing and sieving with amorphous carbon precursors, vibration molding, and sintering to obtain silicon-carbon anode materials. This method achieves uniform dispersion of nano-silicon on the graphite surface, and carbon coating at the exterior to alleviate the volume expansion of the nano-silicon caused during lithium intercalation and deintercalation. However, the highest initial reversible specific capacity of such materials is only 585 mAh/g, which is undesirable for the current capacity requirements.

Therefore, it's an urgent problem to provide a silicon anode material to effectively alleviate volume expansion while having high specific capacity and long cycle life.

### SUMMARY OF THE INVENTION

In view of above issues, the present invention aims to provide a silicon-carbon composite material, a preparation method thereof, and a secondary battery. The silicon-carbon composite material of the present invention can effectively alleviate the significant volume effect of silicon generated during lithium intercalation and deintercalation, and has a higher capacity and improved cycle performance.

To achieve the above objectives, a first aspect of the present invention provides a silicon-carbon composite material including a silicon-carbon composite core and a carbon coating layer coated on the silicon-carbon composite core. The silicon-carbon composite core contains multiple closed pores, such as at least two, three, four, five, or more closed pores. The silicon-carbon composite material is in the form of particles, which may be spherical, ellipsoidal, flat, elongated, block-shaped, flattened spherical, irregular three-dimensional shapes, and so on.

The closed pores in the silicon-carbon composite core of the present invention can effectively alleviate the significant volume effect of silicon generated during lithium intercalation and deintercalation. Additionally, the combination of the silicon-carbon composite core and the carbon coating layer can ensure structural stability and high strength of the material, thereby alleviating the volume effect of silicon generated during lithium intercalation and deintercalation, and providing the material with better cycle performance.

Based on the first aspect, the silicon-carbon composite core refers to a core that includes a silicon material and a carbon material. The carbon coating layer may be at least one layer, such as one layer, two layers, three layers, and so on. Closed pores refer to pores which are formed in closed forms.

In some embodiments, the silicon-carbon composite core includes a carbon filling layer and nano-silicon dispersed in the carbon filling layer, the nano-silicon is doped with nitrogen at a surface thereof, and carbon-nitrogen bonds are formed on surfaces of the carbon filling layer and the nano-silicon.

In some embodiments, the closed pores are dispersed in the carbon filling layer, a wall of each closed pored is formed with a carbon layer, and the carbon-nitrogen bonds are formed on the surface of the carbon filling layer and a surface of the carbon layer.

In some embodiments, a thickness of the carbon layer is 0.1 μm to 2.0 μm, and a weight ratio of the carbon layer to the silicon-carbon composite material is 1% to 10%.

In some embodiments, spacing between adjacent closed pores is 0.5 μm to 1.5 μm.

In some embodiments, a pore diameter of each closed pore is 0.5 μm to 2.0 μm.

In some embodiments, the silicon-carbon composite material satisfies a relational expression (S1-S2)/S1≥50%, where S1 denotes an area of a cross section of the silicon-carbon composite material and S2 denotes a sum of areas of all closed pores in the cross section of the silicon-carbon composite material.

In some embodiments, a total carbon content of the silicon-carbon composite material is 10 wt. % to 60 wt. %.

In some embodiments, a thickness of the carbon coating layer is 0.5 μm to 2.0 μm.

In some embodiments, a weight ratio of the carbon coating layer to the silicon-carbon composite material is 1% to 10%.

In some embodiments, a thickness of the silicon-carbon composite core is ≥1.9 μm, for example ranges from 1.9 μm to 20 μm, or 1.9 μm to 15 μm.

In some embodiments, an initial reversible capacity of the silicon-carbon composite material is 1900 mAh/g.

In some embodiments, an initial Coulombic efficiency of the silicon-carbon composite material is ≥87.8%.

In some embodiments, a capacity retention rate of the silicon-carbon composite material after 100 cycles is ≥89.6%.

A second aspect of the present invention provides preparation method of a silicon-carbon composite material, including steps (I) to (V):
(I) a surface modification treatment of a high-molecular polymer:
treating a surface of a high-molecular polymer with an ultraviolet-ozone (UV-ozone) device to introduce oxygen-containing polar functional groups to the surface thereof;
(II) a preparation of a nano-silicon dispersion:
dissolving and stirring nano-silicon and an amino silane coupling agent in an organic solvent to obtain a nano-silicon dispersion;
(III) a preparation of a first precursor:
adding the high-molecular polymer after the surface modification treatment to the nano-silicon dispersion for stirring, and carrying out spray drying to obtain a first precursor;
(IV) a preparation of a second precursor: under a protective atmosphere, heating the first precursor to a softening temperature of the high-molecular polymer for a first temperature holding treatment, then heating to a thermal decomposition temperature of the high-molecular polymer for a second temperature holding treatment, then conducting a carbonization treatment, and cooling to obtain a second precursor; and
(V) carbon coating:
coating the second precursor with carbon.

Based on the second aspect, a silicon-carbon composite material prepared by the preparation method is provided in the present invention.

The preparation method of the silicon-carbon composite material of the present invention includes at least the following technical effects.

First, when the high-molecular polymer after the surface modification treatment with a UV-ozone device is mixed with the nano-silicon dispersion, amide bonds are formed between the amine groups in the amino silane coupling agent and the oxygen-containing polar functional groups, causing the nano-silicon particles to be absorbed on the surface of the high-molecular polymer in advance to form a “silicon film”. Then, the high-molecular polymer can be uniformly dispersed within the first precursor by spray drying. The high-molecular polymer are softened under the softening temperature, a part of which is conducted with thermal decomposition before carbonization to form multiple closed pores, and the rest of which is conducted with carbonization to form the walls of the closed pores. Such closed pores can effectively alleviate the significant volume effect of silicon generated during lithium intercalation and deintercalation.

Second, after softened, a part of the high-molecular polymer infiltrates between the nano-silicon particles, and is conducted with thermal decomposition and carbonization to form a dense silicon-carbon composite layer with the nano-silicon particles. In such a way, the resulting material has stable structure and high strength, thereby further alleviating the volume effect and improving the cycle stability of the material. Furthermore, the high-molecular polymer after carbonization may also be reacted with the nitrogen element on the surface of the nano-silicon particles to form carbon-nitrogen bonds, thereby improving the conductivity of the material.

Third, a carbon coating layer may be formed by coating the second precursor with carbon, which is combined with the dense silicon-carbon composite layer to stabilize the structure of the material.

In some embodiments, the high-molecular polymer has limited solubility or insolubility in alcohols.

In some embodiments, the high-molecular polymer includes at least one of polyvinyl chloride, poly(methyl methacrylate), polystyrene, polypropylene, polyethylene terephthalate, polyetherimide, polycarbonate, cellulose acetate, polycaprolactam, and polylaurolactam.

In some embodiments, a Dv50 of the high-molecular polymer is 0.5 μm to 5.0 μm.

In some embodiments, the softening temperature of the high-molecular polymer is 100° C. to 300° C.

In some embodiments, the thermal decomposition temperature of the high-molecular polymer is 350° C. to 450° C.

In some embodiments, an ultraviolet (UV) source of the UV-ozone device is a low-pressure mercury lamp.

In some embodiments, an oxygen concentration in a gas introduced into the UV-ozone device is an atmospheric oxygen concentration.

In some embodiments, an ultraviolet (UV) radiation of the UV-ozone device is dual-wavelength, with wavelength ranges of 250 nm to 260 nm and 180 nm to 190 nm, respectively.

In some embodiments, a power of the UV source of the UV-ozone device is 10 W to 50 W.

In some embodiments, a distance between the high-molecular polymer and the UV source during the surface modification treatment with the UV-ozone device is 5.0 cm to 10.0 cm.

In some embodiments, time for the surface modification treatment with the UV-ozone device is 1 min to 10 min.

In some embodiments, a Dv50 of the nano-silicon is 30 nm to 150 nm.

In some embodiments, a mass ratio of the high-molecular polymer, the nano-silicon, and the amino silane coupling agent is (2˜6):(8˜12):1.

In some embodiments, the amino silane coupling agent includes at least one of (3-aminopropyl)triethoxysilane, aniline methyl triethoxysilane, aniline methyl trimethoxysilane, and polyamine alkyl trialkoxysilane.

In some embodiments, a stirring time in the preparation of the nano-silicon dispersion in step (II) is 10 min to 30 min.

In some embodiments, a stirring speed in the preparation of the nano-silicon dispersion in step (II) is 800 rpm to 1300 rpm.

In some embodiments, in the preparation of the first precursor in step (III), the high-molecular polymer after the surface modification treatment is added to the nano-silicon dispersion, and an organic solvent is added to adjust a solid content to 10% to 15%.

In some embodiments, an inlet temperature for the spray drying is 120° C. to 200° C., and an outlet temperature for the spray drying is 70° C. to 120° C.

In some embodiments, the protective atmosphere includes at least one of argon gas, nitrogen gas, and helium gas.

In some embodiments, a temperature of the carbonization treatment is 600° C. to 1100° C.

In some embodiments, time for the first temperature holding treatment is 0.1 h to 1.0 h.

In some embodiments, time for the second temperature holding treatment is 1 h to 3 h.

In some embodiments, time for the carbonization treatment is 2 h to 4 h.

In some embodiments, the second precursor is subjected to post-treatment after the carbon coating, and the post-treatment includes dispersing and sieving.

In some embodiments, the carbon coating is achieved by coating the second precursor with a carbon source, using a method of liquid-phase coating, gas-phase coating, or solid-phase coating.

A third aspect of the present invention provides a use of the silicon-carbon composite material in anode materials. Such silicon-carbon composite materials as anode active materials can meet the requirements of high cycle performance and low expansion.

A fourth aspect of the present invention provides a secondary battery including a cathode material and an anode material, and the anode material includes the silicon-carbon composite material mentioned above, or a silicon-carbon composite material prepared by the preparation method mentioned above.

### BRIEF DESCRIPTION OF THE DRAWINGS

The accompanying drawings facilitate an understanding of the various embodiments of this invention. In such drawings:

FIG. 1 is a structural schematic diagram of the silicon-carbon composite material according to the present invention;

FIG. 2 is a line scan image of a partial cross section of the silicon-carbon composite material in Embodiment 1 according to the present invention; and

FIG. 3 is a line scan image of a partial cross section of the silicon-carbon composite material in Comparative Example 1 according to the present invention.

### DETAILED DESCRIPTION OF ILLUSTRATED EMBODIMENTS

The silicon-carbon composite material of the present invention may be used as an anode active material in a secondary battery. The secondary battery includes a cathode material and an anode material. The cathode material includes at least one of lithium cobalt oxide-based cathode materials, lithium iron phosphate-based cathode materials, lithium nickel cobalt manganese oxide-based cathode materials, and lithium nickel cobalt aluminum oxide-based cathode materials. The silicon-carbon composite material may be used as an anode active material separately or mixed with other anode active materials such as silicon-based materials, natural graphite, artificial graphite, soft carbon, and/or hard carbon. The secondary battery may be a lithium-ion battery, a sodium-ion battery, or a potassium-ion battery.

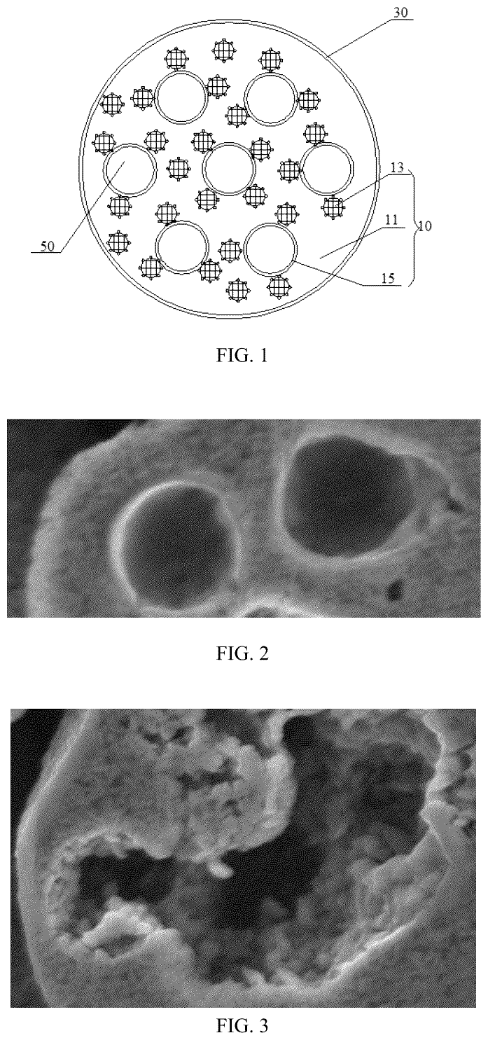

As shown in FIG. 1, the silicon-carbon composite material 100 of the present invention includes a silicon-carbon composite core 10 and a carbon coating layer 30 coated on the silicon-carbon composite core 10, and multiple closed pores 50 are dispersed in the silicon-carbon composite core 10. The silicon-carbon composite core 10 includes a carbon filling layer 11 and nano-silicon 13 filled in the carbon filling layer 11. The closed pores 50 are dispersed in the carbon filling layer 11, and each closed pored 50 is formed with a carbon layer 15 as the wall.

The initial reversible capacity of the silicon-carbon composite material is ≥1900 mAh/g. As exemplary embodiments, the initial reversible capacity of the silicon-carbon composite material may be, but not limited to ≥1900 mAh/g, 1930 mAh/g, 1950 mAh/g, 1970 mAh/g, 1990 mAh/g, 2000 mAh/g, 2030 mAh/g, 2060 mAh/g, 2090 mAh/g, or 2100 mAh/g. The initial Coulombic efficiency of the silicon-carbon composite material is ≥87.8%. As exemplary embodiments, the initial Coulombic efficiency of the silicon-carbon composite material may be, but not limited to ≥87.8%, 88.1%, 88.5%, 88.8%, 89.0%, 89.5%, 89.8%, 90.0%, 90.3%, 90.5%, 90.8%, or 91.0%. The capacity retention rate of the silicon-carbon composite material after 100 cycles is ≥89.6%. For example, the capacity retention rate of the silicon-carbon composite material after 100 cycles may be, but not limited to ≥89.6%, 90.0%, 90.5%, 91.0%, 91.5%, 92.0%, 92.5%, 93.0%, 93.5%, 94.0%, 94.5%, 95.0%, 95.5%, 96.0%, 96.5%, 97.0%, 97.5%, 98.0%, 98.5%, or 99.0%. As an embodiment, the total carbon content of the silicon-carbon composite material is 10 wt. % to 60 wt. %. In some embodiments, the total carbon content of the silicon-carbon composite material is 10 wt. % to 55 wt. %. In other embodiments, the total carbon content of the silicon-carbon composite material is 20 wt. % to 50 wt. %. For example, the total carbon content of the silicon-carbon composite material may be, but not limited to 10 wt. %, 20 wt. %, 30 wt. %, 40 wt. %, 50 wt. %, or 60wt. %.

As an embodiment, the thickness of the silicon-carbon composite core is ≥1.9 μm, for example, 1.9 μm to 20 μm, 1.9 μm to 15 μm, 2 μm to 15 μm, 3 μm to 15 μm, 4 μm to 15 μm, 5 μm to 15 μm, 2 ∞m to 14 μm, 2 μm to 13 μm, 2 μm to 12 μm, 2 μm to 11 μm, 2 μm to 10 μm. The surface of the nano-silicon in the silicon-carbon composite core is doped with nitrogen, and carbon-nitrogen bonds are formed on the surfaces of the carbon filling layer and the nano-silicon, thereby improving the conductivity of the material.

The walls of the closed pores are composed of a carbon layer, and the carbon-nitrogen bonds are formed on the surfaces of the carbon layer and the nano-silicon. The thickness of the carbon layer ranges from 0.1 μm to 2.0 μm. As exemplary embodiments, the thickness of the carbon layer may be, but not limited to 0.1 μm, 0.3 μm, 0.5 μm, 0.8 μm, 1.0 μm, 1.3 μm, 1.6 μm, 1.8 μm, or 2.0 μm. The weight ratio of the carbon layer to the silicon-carbon composite material ranges from 1% to 10%. As exemplary embodiments, the weight ratio of the carbon layer to the silicon-carbon composite material may be, but not limited to 1%, 2%, 3%, 4%, 5%, 6%, 7%, 8%, 9%, or 10%. As an embodiment, the spacing between adjacent closed pores ranges from 0.5 μm to 1.5 μm. As exemplary embodiments, the spacing between the adjacent closed pores may be, but not limited to 0.5 μm, 0.7 μm, 0.9 μm, 1.0 μm, 1.2 μm, 1.4 μm, or 1.5 μm. As an embodiment, the pore diameter of the closed pores ranges from 0.5 μm to 2.0 μm. As exemplary embodiments, the diameter of the closed pores may be, but not limited to 0.5 μm, 0.7 μm, 0.9 μm, 1.0 μm, 1.1 μm, 1.3 μm, 1.5 μm, 1.7 μm, 1.9 μm, or 2.0 μm.

The silicon-carbon composite material meets a relational expression (S1-S2)/S1≥50%, ≥60%, ≥70%, or ≥80%. Optionally, (S1-S2)/S1≤90%. Preferably, S2/S1≤50%, optionally, S2/S1≤10%, ≤20%, ≤30%, or ≤40%, where S1 denotes an area of a cross section of the silicon-carbon composite material, and S2 denotes a sum of the areas of all closed pores in the cross section of the silicon-carbon composite material.

The thickness of the carbon coating layer ranges from 0.5 μm to 2.0 μm. As exemplary embodiments, the thickness of the carbon coating layer may be, but not limited to 0.5 μm, 0.8 μm, 1.0 μm, 1.3 μm, 1.6 μm, 1.8 μm, or 2.0 μm. The weight ratio of the carbon coating layer to the silicon-carbon composite material ranges from 1% to 10% of the weight of the silicon-carbon composite material. As exemplary embodiments, the weight ratio of the carbon coating layer to the silicon-carbon composite material may be, but not limited to 1%, 2%, 3%, 4%, 5%, 6%, 7%, 8%, 9%, or 10%.

The preparation method of the silicon-carbon composite material includes Steps (I) to (V).

Step (I) involves a surface modification treatment of a high-molecular polymer: treating a surface of a high-molecular polymer with a UV-ozone device to introduce oxygen-containing polar functional groups to the surface thereof.

Specifically, the high-molecular polymer may be in a solid state and has limited solubility or insolubility in alcohols. As an embodiment, the high-molecular polymers includes at least one of polyvinyl chloride, poly(methyl methacrylate), polystyrene, polypropylene, polyethylene terephthalate, polyetherimide, polycarbonate, cellulose acetate, polycaprolactam, and polylaurolactam. The carbon-hydrogen groups on the surface of such high-molecular polymers can absorb UV light during the surface modification treatment using the UV-ozone device, thereby enhancing the surface activity of the high-molecular polymer.

As an embodiment, the Dv50 (median particle size) of the high-molecular polymer ranges from 0.5 μm to 5.0 μm. As exemplary embodiments, the Dv50 of the high-molecular polymer may be, but not limited to 0.5 μm, 1.0 μm, 1.5 μm, 2.0 μm, 2.5 μm, 3.0 μm, 3.5 μm, 4.0 μm, 4.5 μm, or 5.0 μm. The softening temperature of the high-molecular polymer ranges from 100° C. to 300° C. As exemplary embodiments, the softening temperature of the high-molecular polymer may be, but not limited to 100° C., 120° C., 150° C., 170° C., 200° C., 220° C., 240° C., 260° C., 280° C., or 300° C. The thermal decomposition temperature of the high-molecular polymer ranges from 350° C. to 450° C. As exemplary embodiments, thermal decomposition temperature of the high-molecular polymer may be, but not limited to 350° C., 360° C., 370° C., 380° C., 390° C., 400° C., 410° C., 420° C., 430° C., 440° C., or 450° C.

When a solid high-molecular polymer is subjected to the surface modification treatment using the UV-ozone device, the surface of the high-molecular polymer is exposed to an active environment formed by UV-ozone, which contains a large number of active particles such as atomic oxygen, excited molecular oxygen, and reactive free radicals. Under the irradiation of two wavelengths of short-wave UV light (wavelength ranging from 250 nm to 260 nm and 180 nm to 190 nm, respectively), ozone is continuously generated and decomposed, leading to the accumulation of atomic oxygen and molecular oxygen. Atomic oxygen exists in the forms of O(³P) (produced mainly at wavelengths of 180 nm to 190 nm) and O(¹D) (produced mainly at wavelengths of 250 nm to 260 nm), and the both forms of oxygen act as strong oxidants on the carbon-hydrogen compounds on the surface of the high-molecular polymer, which results in rapid oxidation. Additionally, most carbon-hydrogen compounds absorb UV light at both wavelengths, thus the surface activity of the polymer is enhanced.

Specifically, mechanisms of the generation and photolysis of ozone are as follows.

Molecular oxygen O₂ (3Σ_{g}⁻) absorbs UV light with wavelengths between 180 nm and 190 nm, to form excited state molecular oxygen O₂*(3Σᵤ⁻):

O₂(3Σ_{g}⁻)+hv(180 nm-190 nm)→O₂*(3Σᵤ⁻) (1).

The excited state molecular oxygen O₂*(3Σᵤ⁻) is overlapped with the repulsive electronic state O₂*(3Πᵤ). This overlap allows the molecular oxygen to transition from a high-energy electronic state to a lower-energy electronic state:

O₂*(3Σᵤ⁻)→O₂*(3Πᵤ) (2).

The repulsive electronic state O₂*(3Πᵤ) can dissociate to form two ground state oxygen atoms O(³P):

O₂*(3Πᵤ)→2O(³P) (3).

The ground state oxygen atoms O(³P) react with molecular oxygen to form ozone:

O(³P)+O₂(3Σ_{g}⁻)→O₃ (4).

Under UV light irradiation at wavelengths between 250 nm and 260 nm, ozone undergoes photolysis to form atomic oxygen O(¹D) and molecular oxygen. The oxygen-containing polar functional groups on the surface of the high-molecular polymer treated by UV-ozone will react with the amine groups in the silane coupling agent on the surface of the nano-silicon through esterification, allowing the nano-silicon particles to adsorb onto the surface of the polymer in advance. This not only ensures the uniform dispersion of the high-molecular polymer inside the particles during spray granulation but also allows the formation of carbon-nitrogen bonds during carbonization, thereby further improving the conductivity of the silicon-carbon composite material.

As an embodiment, the model of the UV-ozone device may be, but not limited to, BZD250-S from Shenzhen Huiwo Technology Co., Ltd. The UV light source of the UV-ozone device may be a low-pressure mercury lamp. The oxygen concentration in the gas supplied to the UV-ozone device is the atmospheric oxygen concentration. As an embodiment, the power of the UV light source of the UV-ozone device is 10 W to 50 W, for example, 10 W to 30 W or 10 W to 20 W. As exemplary embodiments, the power of the UV light source of the UV-ozone device may be, but not limited to, 10 W, 11 W, 12 W, 13 W, 14 W, 15 W, 16 W, 17 W, 18 W, 19 W, or 20 W. When the UV-ozone device is used for surface modification treatment of a solid high-molecular polymer, as an embodiment, the distance between the high-molecular polymer and the UV light source is 5.0 cm to 10.0 cm, for example, 6.0 cm to 9.0 cm or 6.0 cm to 7.5 cm. As exemplary embodiments, the distance between the high-molecular polymer and the UV light source may be, but not limited to, 6.0 cm, 6.1 cm, 6.2 cm, 6.3 cm, 6.4 cm, 6.5 cm, 6.6 cm, 6.7 cm, 6.8 cm, 6.9 cm, 7.0 cm, 7.1 cm, 7.2 cm, 7.3 cm, 7.4 cm, or 7.5 cm. As an embodiment, the time for the surface modification treatment with the UV-ozone device is 1 min to 10 min, for example, 1 min to 8 min or 1 min to 5 min. As exemplary embodiments, the time for the surface modification treatment may be, but not limited to, 1 min, 2 min, 3 min, 4 min, 5 min, 6 min, 7 min, 8 min, 9 min, or 10 min.

Step (II) involves a preparation of nano-silica dispersion: dissolving and stirring nano-silicon and an amino silane coupling agent in an organic solvent to obtain a nano-silicon dispersion.

As an embodiment, the Dv50 of the nano-silicon ranges from 30 nm to 150 nm, for example, 50 nm to 150 nm, or 50 nm to 130 nm. As exemplary embodiments, the Dv50 of the nano-silicon may be, but not limited to 30 nm, 40 nm, 50 nm, 60 nm, 70 nm, 80 nm, 90 nm, 100 nm, 110 nm, 120 nm, 130 nm, 140 nm, or 150nm. The mass ratio of the high-molecular polymer, the nano-silicon, and the amino silane coupling agent is (2˜6):(8˜12):1. As exemplary embodiments, the mass ratio may be, but not limited to 2:8:1, 2:9:1, 2:10:1, 2:11:1, 2:12:1, 3:9:1, 3:10:1, 3:11:1, 3:12:1, 4:9:1, 4:10:1, 4:11:1, 4:12:1, 5:9:1, 5:10:1, 5:11:1, 5:12:1, 6:9:1, 6:10:1, 6:11:1, or 6:12:1. The amino silane coupling agent may include at least one of (3-aminopropyl)triethoxysilane, aniline methyl triethoxysilane, aniline methyl trimethoxysilane, and polyaminated alkyltrimethoxysilane.

As an embodiment, the stifling time is 10 min to 30 min. As an embodiment, the stifling speed is 800 rpm to 1300 rpm.

As an embodiment, in the stirring state, the high-molecular polymer after the surface modification treatment is added to the nano-silicon dispersion, and an organic solvent is added to adjust the solid content to 10% to 15%, for example, 12% to 15% or 14% to 15%. The organic solvent may include, but not limited to ethanol, acetone, or isopropanol. As exemplary embodiments, the solid content adjusted by the organic solvent may be, but not limited to 10%, 11%, 12%, 13%, 14%, or 15%.

Step (III) involves a preparation of a first precursor: adding the high-molecular polymer after the surface modification treatment to the nano-silicon dispersion for stifling, and carrying out spray drying to obtain a first precursor.

As an embodiment, the inlet temperature for spray drying is 120° C. to 200° C., for example, 120° C. to 170° C. or 130° C. to 150° C. As exemplary embodiments, the inlet temperature for spray drying may be, but not limited to 120° C., 130° C., 140° C., 150° C., 160° C., 170° C., 180° C., 190° C., or 200° C. As an embodiment, the outlet temperature for spray drying is 70° C. to 120° C., for example, 70° C. to 100° C. or 70° C. to 90° C. As exemplary embodiments, the outlet temperature for spray drying may be, but not limited to 70° C., 80° C., 90° C., 100° C., 110° C., or 120° C.

Step (IV) involves a preparation of a second precursor: under a protective atmosphere, heating the first precursor to a softening temperature of the high-molecular polymer for a first temperature holding treatment, then heating to a thermal decomposition temperature of the high-molecular polymer for a second temperature holding treatment, then conducting a carbonization treatment, and cooling to obtain a second precursor.

As an embodiment, the protective atmosphere includes at least one of argon, nitrogen, and helium. The time for the first temperature holding treatment is between 0.1 h and 1.0 h, as exemplary embodiments, may be, but not limited to 0.1 h, 0.2 h, 0.3 h, 0.4 h, 0.5 h, 0.6 h, 0.7 h, 0.8 h, 0.9 h, or 1.0 h. The time for the second temperature holding treatment is between 1 h and 3 h, as exemplary embodiments, may be, but not limited to 1 h, 2 h, or 3 h. As an embodiment, the temperature for the carbonization treatment is between 600° C. and 1100° C., for example, between 600° C. and 900° C., or between 650° C. and 750° C. As exemplary embodiments, the temperature for the carbonization treatment may be, but not limited to 600° C., 650° C., 700° C., 750° C., 800° C., 850° C., 900° C., 950° C., 1000° C., 1050° C., or 1100° C. The time for the carbonization treatment is between 2 h and 4 h, as exemplary embodiments, may be, but not limited to 2 h, 3 h, or 4 h.

Step (V) involves carbon coating: coating the second precursor with carbon.

As an embodiment, the carbon coating is achieved by coating the second precursor with a carbon source, using a coating method of liquid-phase coating, gas-phase coating, or solid-phase coating. Other coating methods such as plasma also may be used, as long as a carbon coating layer is formed. The carbon coating layer can be one layer, two layers, three layers, and so on. It should be noted that, the silicon-carbon composite material of the present invention is not limited to the coating methods or the number of the carbon coating layers.

As an embodiment, the gas-phase coating may be achieved by a chemical vapor deposition (CVD) method, which includes adding the second precursor into a CVD furnace, and introducing a gaseous carbon source under a protective atmosphere to obtain the silicon-carbon composite material.

In the gas-phase coating, the protective atmosphere may include at least one of argon, nitrogen, and helium. The flow rate of the protective atmosphere is between 4 L/min and 10 L/min. As exemplary embodiments, the flow rate of the protective atmosphere may be, but not limited to 4 L/min, 5 L/min, 6 L/min, 7 L/min, 8 L/min, 9 L/min, or 10 L/min. The reaction temperature is between 700° C. and 1100° C. As exemplary embodiments, the reaction temperature may be, but not limited to 700° C., 800° C., 900° C., 1000° C., or 1100° C. The heating rate is between 5° C./min and 10° C./min. As exemplary embodiments, the heating rate may be, but not limited to 5° C./min, 6° C./min, 7° C./min, 8° C./min, 9° C./min, or 10° C./min. The gaseous carbon source may include at least one of alkanes, alkenes, and alkynes. As exemplary embodiments, the alkanes include at least one of methane, ethane, and propane. The alkenes include ethylene and/or propylene. The alkynes include acetylene and/or propyne. The flow rate of the gaseous carbon source is between 0.5 L/min and 3.0 L/min. As exemplary embodiments, the flow rate of the gaseous carbon source may be, but not limited to, 0.5 L/min, 1.0 L/min, 1.5 L/min, 2.0 L/min, 2.5 L/min, or 3.0 L/min. The introduction time of the gaseous carbon source is between 4 h and 8 h. As exemplary embodiments, the introduction time of the gaseous carbon source may be, but not limited to, 4 h, 5 h, 6 h, 7 h, or 8 h.

As an embodiment, the liquid-phase coating may include: mixing an organic carbon source, a solvent, and a second precursor to obtain a homogeneous mixture, and then carbonizing the mixture after spray drying to obtain a silicon-carbon composite material.

In the liquid-phase coating, the organic carbon source may include, but not limited to at least one of polyvinyl alcohol, glucose, and sucrose. The solvent may include, but not limited to at least one of water, ethanol, acetone, and isopropanol. The temperature for dissolving the organic carbon source in the solvent ranges from 60° C. to 95° C. As exemplary embodiments, the temperature may be, but not limited to 60° C., 63° C., 65° C., 67° C., 70° C., 73° C., 75° C., 77° C., 80° C., 83° C., 86° C., 88° C., 90° C., 92° C., or 95° C. Stirring may be used to accelerate the reaction during the dissolution, and the stifling time may range from 0.5 h to 2.0 h. As exemplary embodiments, the stirring time may be, but not limited to 0.5 h, 0.7 h, 0.9 h, 1.1 h, 1.3 h, 1.5 h, 1.7 h, 1.9 h, or 2.0 h. The carbonization is carried out under a protective atmosphere, which may include at least of nitrogen, argon, and helium. The carbonization temperature ranges from 700° C. to 1100° C. As exemplary embodiments, the carbonization temperature may be, but not limited to 700° C., 800° C., 900° C., 1000° C., or 1100° C. The carbonization time ranges from 2 h to 6 h. As exemplary embodiments, the carbonization time may be, but not limited to 2 h, 3 h, 4 h, 5 h, or 6 h. The heating rate for the carbonization ranges from 1° C./min to 5° C./min. As exemplary embodiments, the heating rate may be, but not limited to 1° C./min, 2° C./min, 3° C./min, 4° C./min, or 5° C./min.

As an embodiment, the solid-phase coating may include: mixing and dispersing a solid carbon source and a second precursor in a high speed to obtain a mixture, and then carbonizing the mixture under a protective atmosphere to obtain a silicon-carbon composite material.

In the solid-phase coating, the solid carbon source may include, but not limited to solid pitch, glucose, sucrose, and phenolic resin. The mixing and dispersing may be performed using conventional devices and parameters. The carbonization temperature for the solid-phase coating ranges from 700° C. to 1100° C. As exemplary embodiments, the carbonization temperature may be, but not limited to 700° C., 800° C., 900° C., 1000° C., or 1100° C. The carbonization time ranges from 2 h to 6 h. As exemplary embodiments, the carbonization time may be, but not limited to 2 h, 3 h, 4 h, 5 h, or 6 h. The heating rate for the carbonization ranges from 1° C./min to 5° C./min. As exemplary embodiments, the heating rate may be, but not limited to 1° C./min, 2° C./min, 3° C./min, 4° C./min, or 5° C./min.

As an embodiment, the second precursor may be subjected to post-treatment after the carbon coating, which includes dispersing and sieving. The dispersing method may be, but not limited to VC dispersion. The rotational speed for the dispersion ranges from 500 rpm to 3000 rpm. As exemplary embodiments, the rotational speed may be, but not limited to 500 rpm, 600 rpm, 700 rpm, 800 rpm, 900 rpm, 1000 rpm, 1100 rpm, 1200 rpm, 1300 rpm, 1400 rpm, 1500 rpm, 2000 rpm, 2500 rpm, or 3000 rpm. The dispersion time ranges from 30 min to 120 min. As exemplary embodiments, the dispersion time may be, but not limited to 30 min, 40 min, 50 min, 60 min, 70 min, 80 min, 90 min, 100 min, 110 min, or 120 min. A sieve is used for the sieving, with a mesh size ranging from 100 meshes to 500 meshes. As exemplary embodiments, the mesh size of the sieve may be, but not limited to 100 meshes, 130 meshes, 150 meshes, 170 meshes, 200 meshes, 230 meshes, 250 meshes, 300 meshes, 350 meshes, 400 meshes, 450 meshes, or 500 meshes.

To better illustrate the purposes, technical solutions, and beneficial effects of the present invention, specific embodiments will be provided. It should be noted that the following embodiments are further explanations of the present invention and should not be considered as limitations of the present invention.

### Embodiment 1

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

The line scan image of a cross section of the prepared silicon-carbon composite material is shown in FIG. 2. The silicon-carbon composite material includes a silicon-carbon composite core and a carbon coating layer coated on the silicon-carbon composite core. The silicon-carbon composite core includes a carbon filling layer and nano-silicon dispersed in the carbon filling layer. The silicon-carbon composite core contains closed pores with a spacing of 0.5 μm to 1.0 μm, a pore diameter of 1.5 μm to 2.0 μm, and a porosity ratio (S1-S2)/S1 is approximately 60%. The closed pores are evenly distributed in a high proportion and have a similar size. After detected, the total carbon content of the silicon-carbon composite material is 35 wt. %, and the thickness of the carbon coating layer is approximately 1.5 μm, the weight ratio of the carbon coating layer to the silicon-carbon composite material is 6%, the thickness of the silicon-carbon composite core is approximately 8 μm, the thickness of the carbon layer is approximately 0.1 μm, and the weight ratio of the carbon layer to the silicon-carbon composite material is 5%.

### Embodiment 2

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 1.5 kg of nano-silicon (Dv50 of 100 nm) and 0.15 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 3

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 1.0 kg of nano-silicon (Dv50 of 100 nm) and 0.10 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 4

The present embodiment is a preparation method for a silicon-carbon composite material, including the following steps:
(I) a surface modification treatment of a high-molecular polymer:
placing 0.5 kg of polycarbonate particles with a Dv50 of 2 μm in a UV-ozone device, with a low-pressure mercury lamp with a power of 10 W as the UV light source; and exposing the polycarbonate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polycarbonate particles;
(II) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polycarbonate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 245° C. at a heating rate of 1° C./min for a first temperature holding treatment for 0.5 h, then heating to 380° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 5

The present embodiment is a preparation method for a silicon-carbon composite material, including the following steps:
(I) a surface modification treatment of a high-molecular polymer:
placing 0.5 kg of polycarbonate particles with a Dv50 of 2 μm in a UV-ozone device, with a low-pressure mercury lamp with a power of 10 W as the UV light source; and exposing the polycarbonate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polycarbonate particles;
(II) a preparation of a nano-silicon dispersion:
mixing 1.5 kg of nano-silicon (Dv50 of 100 nm) and 0.15 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polycarbonate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 245° C. at a heating rate of 1° C./min for a first temperature holding treatment for 0.5 h, then heating to 380° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 6

The present embodiment is a preparation method for a silicon-carbon composite material, including the following steps:
(I) a surface modification treatment of a high-molecular polymer:
placing 0.5 kg of polycarbonate particles with a Dv50 of 2 μm in a UV-ozone device, with a low-pressure mercury lamp with a power of 10 W as the UV light source; and exposing the polycarbonate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polycarbonate particles;
(II) a preparation of a nano-silicon dispersion:
mixing 1.0 kg of nano-silicon (Dv50 of 100 nm) and 0.10 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polycarbonate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 245° C. at a heating rate of 1° C./min for a first temperature holding treatment for 0.5 h, then heating to 380° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 7

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 100 nm) and 0.20 kg of aniline methyl trimethoxysilane in ethanol to obtain a mixture with a solid content of 10 wt. %, and stirring the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Embodiment 8

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stirring the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
dissolving PVA in deionized water, stirring at 100° C. for 1.5 h to prepare a PVA solution with a mass fraction of 1.5%, then mixing the PVA solution with the second precursor and stirring at 90° C. for 1 h to obtain a mixture, spray drying the mixture and placing in a carbonization furnace to heat to 1100° C. at a rate of 5° C./min for carbonization treatment for 7 h, and then naturally cooling to room temperature, and dispersing at 800 rpm for 100 min using a VC dispersing machine and sieving through a 400-mesh sieve.

### Embodiment 9

The present embodiment is a preparation method for a silicon-carbon composite material, including the following steps:
(I) a surface modification treatment of a high-molecular polymer:
placing 1.0 kg of polyethylene terephthalate particles with a Dv50 of 3 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 120 nm) and 0.20 kg of (3-aminopropyl)triethoxysilane in ethanol to obtain a mixture with a solid content of 8 wt. %, and stifling the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 13%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(V) carbon coating:
placing the second precursor in a CVD furnace and heating to 700° C. at a heating rate of 5° C./min, introducing an argon gas at a flow rate of 4 L/min and an methane gas at a flow rate of 0.5 L/min for 4 h, respectively, and then naturally cooling to room temperature, and dispersing at 1000 rpm for 60 min and sieving through a 400-mesh sieve.

### Embodiment 10

The present embodiment is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 30 W as the UV light source; and exposing the polyethylene terephthalate particles to UV radiation under atmospheric conditions at a distance of 5 cm from the UV light source for 3 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 120 nm) and 0.20 kg of (3-aminopropyl)triethoxysilane in ethanol to obtain a mixture with a solid content of 10 wt. %, and stirring the mixture at 1000 rpm for 20 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 40 min and then carrying out spray drying (with inlet temperature of 180° C., and outlet temperature of 100° C.) to obtain a first precursor;
(IV) a preparation of a second precursor:
placing the first precursor in a reactor under a nitrogen atmosphere, heating to 230° C. at a heating rate of 2° C./min for a first temperature holding treatment for 1.0 h, then heating to 417° C. for a second temperature holding treatment for 1.5 h, and then heating to 1000° C. for a carbonization treatment for 2 h, and cooling to room temperature to obtain a second precursor;
(V) carbon coating:
placing the second precursor in a CVD furnace and heating to 800° C. at a heating rate of 3° C./min, introducing a nitrogen gas at a flow rate of 5 L/min and an acetylene gas at a flow rate of 1.5 L/min for 3 h, respectively, and then naturally cooling to room temperature, and dispersing at 1200 rpm for 40 min and sieving through a 400-mesh sieve.

### Comparative Example 1

The present example is a preparation method for a silicon-carbon composite material, including the following steps:
(I) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stirring the mixture at 900 rpm for 30 min to obtain a nano-silicon dispersion;
(II) a preparation of the first precursor:
adding polyethylene terephthalate to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(III) a preparation of a second precursor:
placing the first precursor in a reactor under a nitrogen atmosphere, heating to 230° C. at a heating rate of 1° C./min for a first temperature holding treatment for 0.5 h, then heating to 417° C. for a second temperature holding treatment for 2 h, and then heating to 900° C. for a carbonization treatment for 3 h, and cooling to room temperature to obtain a second precursor;
(IV) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

The line scan image of a cross section of the prepared silicon-carbon composite material is shown in FIG. 3. The silicon-carbon composite material of Comparative Example 1 includes a silicon-carbon composite core and a carbon coating layer coated on the silicon-carbon composite core. The silicon-carbon composite core includes a carbon filling layer and nano-silicon dispersed within the carbon filling layer. The nano-silicon particles are randomly distributed within the carbon filling layer, and the pores formed in the silicon-carbon composite core are interconnected and unevenly distributed within the silicon-carbon composite material, which could not effectively alleviate the volume effect of silicon.

### Comparative Example 2

The present example is a preparation method for a silicon-carbon composite material, including the following steps:
(I) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stirring the mixture at 900 rpm for 30 min to obtain a nano-silicon dispersion;
(II) a preparation of the first precursor:
adding polycarbonate to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(III) a preparation of a second precursor:
placing the first precursor in a reactor under a nitrogen atmosphere, heating to 245° C. at a heating rate of 1° C./min for a first temperature holding treatment for 0.5 h, then heating to 380° C. for a second temperature holding treatment for 2 h, and then heating to 900° C. for a carbonization treatment for 3 h, and cooling to room temperature to obtain a second precursor;
(IV) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

### Comparative Example 3

The present example is a preparation method for a silicon-carbon composite material, including the following steps:
(I) a surface modification treatment of a high-molecular polymer:
placing 0.5 kg of polyethylene terephthalate particles with a Dv50 of 2 μm in a UV-ozone device, with a low-pressure mercury lamp with a power of 10 W as the UV light source; and exposing the polyethylene terephthalate particles to UV radiation under atmospheric conditions at a distance of 7 cm from the UV light source for 5 min, with the UV radiation having dual wavelengths of 254 nm and 184 nm, respectively, to form oxygen-containing polar functional groups on the surfaces of the polyethylene terephthalate particles;
(II) a preparation of a nano-silicon dispersion:
mixing 2.0 kg of nano-silicon (Dv50 of 100 nm) and 0.20 kg of (3-aminopropyl)triethoxysilane in ethanol to obtain a mixture with a solid content of 10 wt. %, and stifling the mixture at 900 rpm for 30 min to obtain a nano-silicon dispersion;
(III) a preparation of the first precursor:
adding the polyethylene terephthalate after the surface modification treatment to the nano-silicon dispersion under stirring, and adding anhydrous ethanol to achieve a solid content of 15%, continuously stirring for 30 min and then carrying out spray drying (with inlet temperature of 130° C., and outlet temperature of 80° C.) to obtain a first precursor;
(IV) a preparation of a second precursor:
placing the first precursor in a reactor under a nitrogen atmosphere, heating to 900° C. at a heating rate of 1° C./min for a carbonization treatment for 5 h, and cooling to room temperature to obtain a second precursor;
(V) carbon coating:
placing the second precursor in a CVD furnace and heating to 700° C. at a heating rate of 5° C./min, introducing a nitrogen gas at a flow rate of 4 L/min and an acetylene gas at a flow rate of 0.5 L/min for 4 h, respectively, and then naturally cooling to room temperature, and dispersing at 1000 rpm for 60 min and sieving through a 400-mesh sieve.

The silicon-carbon composite materials prepared in Embodiments 1 to 10 and Comparative Examples 1 to 3 were respectively tested for charge-discharge performance and cycle performance, with the following test conditions and test results shown in Table 1.

### (1) Charge-Discharge Performance Test

The silicon-carbon composite materials prepared in Embodiments 1 to 10 and Comparative Examples 1 to 3 were used as active materials to be mixed with a binder, namely an aqueous dispersion of a polyvinylidene fluoride (PVDF) and a conductive agent (Super-P) according to a mass ratio of 70:15:15, a proper amount of N-methylpyrrolidone (NMP) was added to be used as a solvent to prepare a slurry, and the slurry was smeared on a copper foil, dried in vacuum and rolled to prepare anodes. With a lithium metal as a counter electrode, CR2032 button batteries were assembled in a glove box filled with an inert gas with polypropylene microporous membranes as separators, by means of 1 mol/L of an electrolyte which was a LiPF₆ three-component mixed solvent mixed according to EC:DMC:EMC=1:1:1(v/v). The charge-discharge performance of the button batteries was tested by means of a battery test system of LANHE. Specifically, under a normal temperature, the button batteries were discharged to 0.01 V at a constant current of 0.1 C, then further discharged to 0.005 V at a constant current of 0.02 C, and finally charged to 1.5 V at a constant current of 0.1 C. A capacity of the button battery charged to 1.5V is called as an initial charging capacity, and a ratio of the charging capacity to a discharge capacity is called as an initial Coulombic efficiency.

### (2) Cycle Performance Test

The silicon-carbon composite materials prepared in Embodiments 1 to 10 and Comparative Examples 1 to 3 were respectively mixed with graphite as active materials (capacity adjusted to about 500 mAh/g), and then mixed with a binder, namely an aqueous dispersion of an acrylonitrile multipolymer (LA132, solid content 15%), and a conductive agent (Super-P) according to a mass ratio of 70:10:20, a proper amount of water was added to be used as a solvent to prepare a slurry, and the slurry was smeared on a copper foil, dried in vacuum and rolled to prepare anodes. With a lithium metal as a counter electrode, CR2032 button batteries were assembled in a glove box filled with an inert gas with polypropylene microporous membranes as separators, by means of 1 mol/L of an electrolyte which was a LiPF₆ three-component mixed solvent mixed according to EC:DMC:EMC=1:1:1(v/v). The charge-discharge performance of the button batteries was tested by means of a battery test system of LANHE. Specifically, under a normal temperature, the button batteries were charged and discharged at a constant current of 0.1 C, with the charge and discharge voltage limited between 0.005 V to 1.5 V, and the capacity retention rate and the expansion rate after 100 cycles were calculated.

$$Capacity retention rate = \frac{Charging capacity of 100 th cycle}{Charging capacity of 1 st cycle} \times 100 \%$$

$$Expansion rate = \frac{\begin{matrix}Thickness of anode after 100 cycles - \\ Thickness of anode before cycles\end{matrix}}{\begin{matrix}Thickness of anode before cycles - \\ Thickness of copper foil\end{matrix}} \times 100 \%$$

TABLE 1
results of electrochemical performance test for
each Embodiment and each Comparative Example

| | Charge-discharge performance | | | Cycle performance (for 100 cycles) | | |
|---|---|---|---|---|---|---|
| | Initial | Initial | Initial | Initial | | |
| | charging | discharging | Coulombic | discharging | Capacity | Expansion |
| | capacity | capacity | efficiency | capacity | retention | rate |
| Example | (mAh/g) | (mAh/g) | (%) | (mAh/g) | rate (%) | (%) |
| Embodiment | 2182.7 | 1931.7 | 88.7 | 502.3 | 91.3 | 42.5 |
| 1 | | | | | | |
| Embodiment | 2287.1 | 2008.1 | 87.8 | 501.8 | 89.6 | 47.3 |
| 2 | | | | | | |
| Embodiment | 2230.9 | 1965.4 | 88.5 | 502.0 | 90.5 | 44.1 |
| 3 | | | | | | |
| Embodiment | 2171.1 | 1945.3 | 89.6 | 501.9 | 92.1 | 40.6 |
| 4 | | | | | | |
| Embodiment | 2164.5 | 1928.6 | 88.9 | 500.7 | 91.2 | 42.4 |
| 5 | | | | | | |
| Embodiment | 2252.7 | 1989.1 | 88.1 | 502.4 | 90.4 | 45.1 |
| 6 | | | | | | |
| Embodiment | 2180.8 | 1933.2 | 88.6 | 501.8 | 91.2 | 42.3 |
| 7 | | | | | | |
| Embodiment | 2190.3 | 1938.5 | 88.5 | 502.0 | 91.4 | 42.6 |
| 8 | | | | | | |
| Embodiment | 2172.8 | 1909.9 | 87.9 | 500.6 | 90.0 | 45.0 |
| 9 | | | | | | |
| Embodiment | 2196.4 | 1954.8 | 89.0 | 501.5 | 91.6 | 41.9 |
| 10 | | | | | | |
| Comparative | 1893.3 | 1296.9 | 68.5 | 500.9 | 73.8 | 65.5 |
| Example 1 | | | | | | |
| Comparative | 1680.8 | 1200.1 | 71.4 | 501.5 | 75.2 | 63.4 |
| Example 2 | | | | | | |
| Comparative | 1760.7 | 1198.6 | 68.1 | 500.3 | 68.6 | 68.3 |
| Example 3 | | | | | | |

It's seen from the results of Table 1 that, the silicon-carbon composite materials obtained from Embodiments 1 to 10 had better charge-discharge performance and cycle performance compared to the Comparative Examples 1 to 3. The high-molecular polymers in Comparative Examples 1 and 2 were not surface-modified with UV-ozone treatment, resulting in uneven dispersion of the high-molecular polymers in the nano-silicon dispersion, and no closed pores evenly distributed after carbonization, thus it's difficult to effectively reduce the volume effect of silicon. In Comparative Example 3, no gradient heating was utilized, thus the high-molecular polymer was mainly formed into the carbon filling layer without a closed-pore structure during carbonization, which results in a poor cycle performance.

Finally, it should be noted that the above embodiments are only used to illustrate the technical solution of the invention and not to limit the scope of protection of the invention. Although the invention is described in detail with reference to the preferable embodiments, it is not limited to those listed in the embodiments. Within the scope of knowledge possessed by a person ordinarily skilled in the art, various modifications or changes can be made without departing from the essence and scope of the present invention.

What is claimed is:

1. A silicon-carbon composite material, comprising a silicon-carbon composite core and a carbon coating layer coated on the silicon-carbon composite core, and multiple closed pores being dispersed in the silicon-carbon composite core.

2. The silicon-carbon composite material according to claim 1, wherein the silicon-carbon composite core comprises a carbon filling layer and nano-silicon dispersed in the carbon filling layer, the nano-silicon is doped with nitrogen at a surface thereof, and carbon-nitrogen bonds are formed on surfaces of the carbon filling layer and the nano-silicon.

3. The silicon-carbon composite material according to claim 2, wherein the closed pores are dispersed in the carbon filling layer, a wall of each closed pored is formed with a carbon layer, and the carbon-nitrogen bonds are formed on the surface of the carbon filling layer and a surface of the carbon layer.

4. The silicon-carbon composite material according to claim 3, wherein a thickness of the carbon layer is 0.1 μm to 2.0 μm, and a weight ratio of the carbon layer to the silicon-carbon composite material is 1% to 10%.

5. The silicon-carbon composite material according to claim 1, wherein spacing between adjacent closed pores is 0.5 μm to 1.5 μm.

6. The silicon-carbon composite material according to claim 1, wherein a pore diameter of each closed pore is 0.5 μm to 2.0 μm.

7. The silicon-carbon composite material according to claim 1, wherein the silicon-carbon composite material meets a relational expression (S1-S2)/S1≥50%, where S1 denotes an area of a cross section of the silicon-carbon composite material and S2 denotes a sum of areas of all closed pores in the cross section of the silicon-carbon composite material.

8. The silicon-carbon composite material according to claim 1, wherein a total carbon content of the silicon-carbon composite material is 10 wt. % to 60 wt. %.

9. The silicon-carbon composite material according to claim 1, wherein a thickness of the carbon coating layer is 0.5 μm to 2.0 μm.

10. The silicon-carbon composite material according to claim 1, wherein a weight ratio of the carbon coating layer to the silicon-carbon composite material is 1% to 10%.

11. The silicon-carbon composite material according to claim 1, wherein a thickness of the silicon-carbon composite core is 1.9 μm.

12. The silicon-carbon composite material according to claim 1, wherein an initial reversible capacity of the silicon-carbon composite material is 1900 mAh/g; an initial Coulombic efficiency of the silicon-carbon composite material is ≥87.8%; and a capacity retention rate of the silicon-carbon composite material after 100 cycles is ≥89.6%.

13. A preparation method of a silicon-carbon composite material, comprising steps of:
(I) a surface modification treatment of a high-molecular polymer:
treating a surface of a high-molecular polymer with an ultraviolet-ozone device to introduce oxygen-containing polar functional groups to the surface thereof;
(II) a preparation of a nano-silicon dispersion:
dissolving and stirring nano-silicon and an amino silane coupling agent in an organic solvent to obtain a nano-silicon dispersion;
(III) a preparation of a first precursor:
adding the high-molecular polymer after the surface modification treatment to the nano-silicon dispersion for stirring, and carrying out spray drying to obtain a first precursor;
(IV) a preparation of a second precursor:
under a protective atmosphere, heating the first precursor to a softening temperature of the high-molecular polymer for a first temperature holding treatment, then heating to a thermal decomposition temperature of the high-molecular polymer for a second temperature holding treatment, then conducting a carbonization treatment, and cooling to obtain a second precursor; and
(V) carbon coating:
coating the second precursor with carbon.

14. The preparation method according to claim 13, wherein the high-molecular polymer has limited solubility or insolubility in alcohols; the high-molecular polymer comprises at least one of polyvinyl chloride, poly(methyl methacrylate), polystyrene, polypropylene, polyethylene terephthalate, polyetherimide, polycarbonate, cellulose acetate, polycaprolactam, and polylaurolactam; a Dv50 of the high-molecular polymer is 0.5 μm to 5.0 μm; the softening temperature of the high-molecular polymer is 100° C. to 300° C.; and the thermal decomposition temperature of the high-molecular polymer is 350° C. to 450° C.

15. The preparation method according to claim 13, wherein an ultraviolet source of the ultraviolet-ozone device is a low-pressure mercury lamp; an oxygen concentration in a gas introduced into the ultraviolet-ozone device is an atmospheric oxygen concentration; an ultraviolet radiation of the ultraviolet-ozone device is dual-wavelength, with wavelength ranges of 250 nm to 260 nm and 180 nm to 190 nm, respectively; a power of the ultraviolet source of the ultraviolet-ozone device is 10 W to 50 W; a distance between the high-molecular polymer and the ultraviolet source during the surface modification treatment with the ultraviolet-ozone device is 5.0 cm to 10.0 cm; and time for the surface modification treatment with the ultraviolet-ozone device is 1 min to 10 min.

16. The preparation method according to claim 13, wherein a Dv50 of the nano-silicon is 30 nm to 150 nm; the amino silane coupling agent comprises at least one of (3-aminopropyl)triethoxysilane, aniline methyl triethoxysilane, aniline methyl trimethoxysilane, and polyamine alkyl trialkoxysilane; a stirring time in the preparation of the nano-silicon dispersion in step (II) is 10 min to 30 min; and a stirring speed in the preparation of the nano-silicon dispersion in step (II) is 800 rpm to 1300 rpm.

17. The preparation method according to claim 13, wherein a mass ratio of the high-molecular polymer, the nano-silicon, and the amino silane coupling agent is (2˜6):(8˜12):1; in the preparation of the first precursor in step (III), the high-molecular polymer after the surface modification treatment is added to the nano-silicon dispersion, and an organic solvent is added to adjust a solid content to 10% to 15%; and an inlet temperature for the spray drying is 120° C. to 200° C., and an outlet temperature for the spray drying is 70° C. to 120° C.

18. The preparation method according to claim 13, wherein the protective atmosphere comprises at least one of argon gas, nitrogen gas, and helium gas; a temperature of the carbonization treatment is 600° C. to 1100° C.; time for the first temperature holding treatment is 0.1 h to 1.0 h; time for the second temperature holding treatment is 1 h to 3 h; and time for the carbonization treatment is 2 h to 4 h.

19. The preparation method according to claim 13, wherein the carbon coating is achieved by coating the second precursor with a carbon source, using a method of liquid-phase coating, gas-phase coating, or solid-phase coating; the second precursor is subjected to post-treatment after the carbon coating, and the post-treatment comprises dispersing and sieving.

20. A secondary battery, comprising a cathode material and an anode material, wherein the anode material comprises the silicon-carbon composite material according to claim 1.
